(19) United States
(12) Patent Application Publication
(10) Pub. No.: US 2024/0306062 A1
(43) Pub. Date: Sep. 12, 2024

(54) Enhanced Roaming

(71) Applicant: Apple Inc., Cupertino, CA (US)

(72) Inventors: Lochan Verma, Danville, CA (US); Yong Liu, Campbell, CA (US); Jarkko L. Kneckt, Los Gatos, CA (US); Brajesh K. Dave, Cupertino, CA (US); Prathamesh S. Deshpande, Cupertino, CA (US)

(21) Appl. No.: 18/420,697

(22) Filed: Jan. 23, 2024

Related U.S. Application Data
(60) Provisional application No. 63/489,140, filed on Mar. 8, 2023.

(51) Int. Cl. H04W 36/08; H04L 5/00; H04W 28/02; H04W 60/06

(52) U.S. Cl. CPC H04W 36/08; H04L 5/0053; H04W 28/0278; H04W 60/06

(57) ABSTRACT

Methods, systems and apparatuses for managing roaming by access points (AP), a controller, and a wireless device are described. The wireless device can indicate intent to roam from a source AP to a target AP. The wireless device, APs, and controller can adjust delivery of uplink and/or downlink data in association with the roam.

### PRIORITY CLAIM

This application claims priority to U.S. Provisional Patent Application No. 63/489,140, entitled “Enhanced Roaming,” filed Mar. 8, 2023, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The present application relates to wireless communications, including techniques for wireless communication using enhanced roaming in wireless local area networks.

### DESCRIPTION OF THE RELATED ART

Wireless communication systems are rapidly growing in usage. Further, wireless communication technology has evolved from voice-only communications to also include the transmission of data, such as Internet and multimedia content. A popular short/intermediate range wireless communication standard is wireless local area network (WLAN). Most modern WLANs are based on the IEEE 802.11 standard (and/or 802.11, for short) and are marketed under the Wi-Fi brand name. WLAN networks can link one or more devices to a wireless access point, which in turn provides connectivity to the wider area Internet.

In 802.11 systems, devices that wirelessly connect to each other are referred to as “stations”, “mobile stations”, “user devices”, “user equipment”, or STA or UE for short. Wireless stations can be either wireless access points or wireless clients (and/or mobile stations). Access points (APs), which are also referred to as wireless routers, act as base stations for the wireless network. APs transmit and receive radio frequency signals for communication with wireless client devices. APs can also couple to the Internet in a wired and/or wireless fashion. Wireless clients operating on an 802.11 network can be any of various devices such as laptops, tablet devices, smart phones, smart watches, or fixed devices such as desktop computers. Some 802.11 networks can include multiple APs. STAs can roam from one AP to another. Wireless client devices can be referred to herein as user equipment (and/or UE for short). Some wireless client devices are also collectively referred to herein as mobile devices or mobile stations (although, as noted above, wireless client devices overall can be stationary devices as well).

Mobile electronic devices can take the form of smart phones or tablets that a user typically carries. Wearable devices (also referred to as accessory devices) are a newer form of mobile electronic device, one example being smart watches. Additionally, low-cost low-complexity wireless devices intended for stationary or nomadic deployment are also proliferating as part of the developing “Internet of Things”. In other words, there is an increasingly wide range of desired device complexities, capabilities, traffic patterns, and other characteristics.

### SUMMARY

Embodiments described herein relate to systems, methods, apparatuses, and mechanisms for coexistence of multiple radio access technologies (RATs).

In some embodiments, a method includes: at a wireless device: associating with a first access point (AP), wherein the first AP is associated with a first group of APs managed by a controller. The method can further comprise determining to roam from the first AP to a second AP among the first group of APs, and in response to the determination to roam: transmitting, to the first AP, a first indication, wherein the first indication sets a power management (PM) bit to a value (e.g., 1); and associating with the second AP. The method can further comprise, subsequently to associating with the second AP, transmitting, to the second AP, a second indication, wherein the second indication indicates to pause downlink traffic to the wireless device for a first period of time while uplink traffic from the wireless device to the second AP is not paused for the first period of time. The method can further comprise, during the first period of time, receiving, from the first AP, first downlink data. The method can further comprise, subsequent to the first period of time, receiving, from the second AP, second downlink data.

In some embodiments, a method includes: at a wireless device: associating with a first access point (AP), wherein the first AP is associated with a first group of APs managed by a controller. The method includes determining to roam from the first AP to a second AP among the first group of APs; and in response to the determination to roam: transmitting, to the first AP, a first indication, wherein the first indication indicates: that the first AP is to clear an uplink reorder buffer of any pending uplink data of the wireless device; and deactivating a first link. The method can include associating with the second AP using the first link; during a first period of time, receiving, from the first AP using a second link, first downlink data; and subsequent to the first period of time, receiving, from the second AP using the first link, second downlink data.

In some embodiments, a method includes: at a first access point (AP): communicating with a controller, wherein the first AP is associated with a first group of APs managed by the controller. The method can further comprise, communicating with a first wireless device and receiving, from the first wireless device, an indication of roaming. In some embodiments, the method can further comprise, in response to the indication of roaming: clearing an uplink reorder buffer of any pending uplink data of the wireless device; and transmitting, to the controller, an indication to discontinue providing downlink data for the first wireless device to the first AP. In some embodiments, the method can further comprise, transmitting, to the first wireless device, first downlink data, the first downlink data received at the first AP prior to transmitting the indication to discontinue providing downlink data.

In some embodiments, a method includes: at a second access point (AP): communicating with a controller, wherein the second AP is associated with a first group of APs managed by the controller. The method can further comprise, communicating with a first wireless device. The method can further comprise, pausing downlink data transmission to the first wireless device for a first period of time in association with the first wireless device roaming from a first AP among the first group of APs. The method can further comprise, resuming downlink data transmission to the first wireless device after the first period of time.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system, according to some embodiments.

FIG. 2 illustrates an example simplified block diagram of a wireless device, according to some embodiments.

FIG. 3 illustrates an example WLAN communication system, according to some embodiments.

FIG. 4 illustrates an example simplified block diagram of a WLAN Access Point (AP), according to some embodiments.

FIG. 5 illustrates an example simplified block diagram of a wireless station (STA), according to some embodiments.

FIG. 6 illustrates an example simplified block diagram of a wireless node, according to some embodiments.

FIG. 7 illustrates an example method of communication, according to some embodiments.

FIGS. 8-12 illustrate example aspects of the method of FIG. 7, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present application. Definitions of some acronyms are provided below:
UE: User Equipment
AP: Access Point
STA: Wireless Station
TX: Transmission/Transmit
RX: Reception/Receive
MLD: Multi-link Device
LAN: Local Area Network
WLAN: Wireless LAN
RAT: Radio Access Technology
QOS: Quality of Service
UL: Uplink
DL: Downlink

### Terminology

The following is a glossary of terms used in this disclosure:

Memory Medium-Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium can include other types of non-transitory memory as well or combinations thereof. In addition, the memory medium can be located in a first computer system in which the programs are executed, or can be located in a second different computer system which connects to the first computer system over a network, such as the Internet. In the latter instance, the second computer system can provide program instructions to the first computer for execution. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium-a memory medium as described above, as well as a physical transmission medium, such as a bus, network, and/or other physical transmission medium that conveys signals such as electrical, electromagnetic, or digital signals.

Computer System-any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (and/or combination of devices) having at least one processor that executes instructions from a memory medium.

Mobile Device (and/or Mobile Station)—any of various types of computer systems devices which are mobile or portable and which performs wireless communications using WLAN communication. Examples of mobile devices include mobile telephones or smart phones (e.g., iPhone™, Android™-based phones), and tablet computers such as iPad™, Samsung Galaxy™, etc. Various other types of devices would fall into this category if they include Wi-Fi or both cellular and Wi-Fi communication capabilities, such as laptop computers (e.g., MacBook™), portable gaming devices (e.g., Nintendo DS™, PlayStation Portable™, Gameboy Advance™, iPhone™), portable Internet devices, and other handheld devices, as well as wearable devices such as smart watches, smart glasses, headphones, pendants, earpieces, etc. In general, the term “mobile device” can be broadly defined to encompass any electronic, computing, and/or telecommunications device (and/or combination of devices) which is easily transported by a user and capable of wireless communication using WLAN or Wi-Fi.

Wireless Device (and/or Wireless Station)—any of various types of computer systems devices which performs wireless communications using WLAN communications. As used herein, the term “wireless device” can refer to a mobile device, as defined above, or to a stationary device, such as a stationary wireless client or a wireless base station. For example, a wireless device can be any type of wireless station of an 802.11 system, such as an access point (AP) or a client station (STA or UE). Further examples include televisions, media players (e.g., AppleTV™, Roku™, Amazon FireTV™, Google Chromecast™, etc.), refrigerators, laundry machines, thermostats, and so forth.

WLAN—The term “WLAN” has the full breadth of its ordinary meaning, and at least includes a wireless communication network or RAT that is serviced by WLAN access points and which provides connectivity through these access points to the Internet. Most modern WLANs are based on IEEE 802.11 standards and are marketed under the name “Wi-Fi”. A WLAN network is different from a cellular network.

Processing Element-refers to various implementations of digital circuitry that perform a function in a computer system. Additionally, processing element can refer to various implementations of analog or mixed-signal (combination of analog and digital) circuitry that perform a function (and/or functions) in a computer or computer system. Processing elements include, for example, circuits such as an integrated circuit (IC), ASIC (Application Specific Integrated Circuit), portions or circuits of individual processor cores, entire processor cores, individual processors, programmable hardware devices such as a field programmable gate array (FPGA), and/or larger portions of systems that include multiple processors.

Automatically-refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure can be initiated by input provided by the user, but the subsequent actions that are performed “automatically” are not specified by the user, e.g., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form can be automatically filled out by the computer system where the computer system (e.g., software executing on the computer system) analyzes the fields of the form and fills in the form without any user input specifying the answers to the fields. As indicated above, the user can invoke the automatic filling of the form, but is not involved in the actual filling of the form (e.g., the user is not manually specifying answers to fields but rather they are being automatically completed). The present specification provides various examples of operations being automatically performed in response to actions the user has taken.

Concurrent-refers to parallel execution or performance, where tasks, processes, signaling, messaging, or programs are performed in an at least partially overlapping manner. For example, concurrency can be implemented using “strong” or strict parallelism, where tasks are performed (at least partially) in parallel on respective computational elements, or using “weak parallelism”, where the tasks are performed in an interleaved manner, e.g., by time multiplexing of execution threads.

Configured to-Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

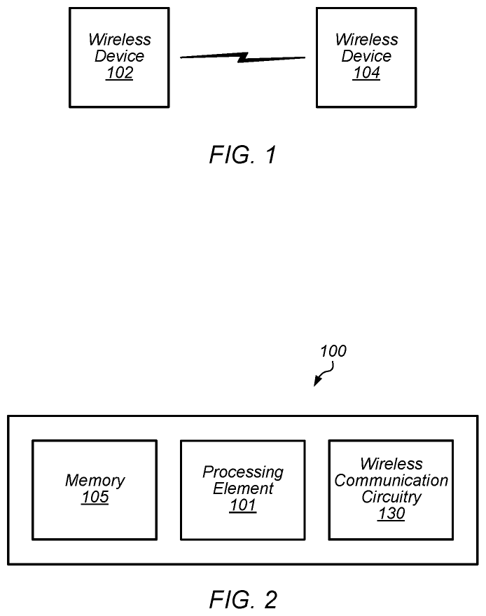

### FIGS. 1-2—Wireless Communication System

FIG. 1 illustrates an exemplary (and simplified) wireless communication system in which aspects of this disclosure can be implemented. It is noted that the system of FIG. 1 is merely one example of a possible system, and embodiments of this disclosure can be implemented in any of various systems, as desired.

As shown, the exemplary wireless communication system includes a (“first”) wireless device 102 in communication with another (“second”) wireless device. The first wireless device 102 and the second wireless device 104 can communicate wirelessly using any of a variety of wireless communication techniques.

As one possibility, the first wireless device 102 and the second wireless device 104 can perform communication using wireless local area networking (WLAN) communication technology (e.g., IEEE 802.11/Wi-Fi based communication) and/or techniques based on WLAN wireless communication. One or both of the wireless device 102 and the wireless device 104 can also be capable of communicating via one or more additional wireless communication protocols, such as any of Bluetooth (BT), Bluetooth Low Energy (BLE), near field communication (NFC), cellular (e.g., 5G NR), etc. One or both of the wireless device 102 and the wireless device 104 can also be capable of using global positioning system (GPS) and/or similar technologies.

The wireless devices 102 and 104 can be any of a variety of types of wireless device. As one possibility, one or more of the wireless devices 102 and/or 104 can be a substantially portable wireless user equipment (UE) device, such as a smart phone, hand-held device, a wearable device such as a smart watch, a tablet, a motor vehicle, or virtually any type of wireless device. As another possibility, one or more of the wireless devices 102 and/or 104 can be a substantially stationary device, such as a set top box, media player (e.g., an audio or audiovisual device), gaming console, desktop computer, appliance, door, access point, base station, or any of a variety of other types of device.

Each of the wireless devices 102 and 104 can include wireless communication circuitry configured to facilitate the performance of wireless communication, which can include various digital and/or analog radio frequency (RF) components, a processor that is configured to execute program instructions stored in memory, a programmable hardware element such as a field-programmable gate array (FPGA), and/or any of various other components. The wireless device 102 and/or the wireless device 104 can perform any of the method embodiments described herein, or any portion of any of the method embodiments described herein, using any or all of such components.

Each of the wireless devices 102 and 104 can include one or more antennas for communicating using one or more wireless communication protocols. In some cases, one or more parts of a receive and/or transmit chain can be shared between multiple wireless communication standards; for example, a device can be configured to communicate using either of Bluetooth or Wi-Fi using partially or entirely shared wireless communication circuitry (e.g., using a shared radio or at least shared radio components). The shared communication circuitry can include a single antenna, or can include multiple antennas (e.g., for MIMO) for performing wireless communications. Alternatively, a device can include separate transmit and/or receive chains (e.g., including separate antennas and other radio components) for each wireless communication protocol with which it is configured to communicate. As a further possibility, a device can include one or more radios or radio components which are shared between multiple wireless communication protocols, and one or more radios or radio components which are used exclusively by a single wireless communication protocol. For example, a device might include a shared radio for communicating using one or more of LTE and/or 5G NR, and separate radios for communicating using Wi-Fi and/or Bluetooth. Other configurations are also possible and contemplated.

As previously noted, aspects of this disclosure can be implemented in conjunction with the wireless communication system of FIG. 1. For example, a wireless device (e.g., either of wireless devices 102 or 104) can be configured to perform methods of communication to improve performance in view of in-device coexistence interference between multiple RATs. For example, by associating with a first AP, associated with a first group of APs managed by a controller, determining to roam from the first AP to a second AP among the first group of APs, and in response to the determination to roam: transmitting, to the first AP, a first indication setting a power management (PM) bit to a value (e.g., 1) and associating with the second AP. Subsequently to associating with the second AP, the device can transmit, to the second AP, a second indication indicating to pause downlink traffic to the wireless device for a first period of time while uplink traffic from the wireless device to the second AP is not paused for the first period of time. During the first period of time, the device can receive, from the first AP, first downlink data and subsequent to the first period of time, receive, from the second AP, second downlink data.

FIG. 2 illustrates an exemplary wireless device 100 (e.g., corresponding to wireless devices 102 and/or 104) that can be configured for use in conjunction with various aspects of the present disclosure. The device 100 can be any of a variety of types of device and can be configured to perform any of a variety of types of functionality. The device 100 can be a substantially portable device or can be a substantially stationary device, potentially including any of a variety of types of device. The device 100 can be configured to perform one or more wireless communication techniques or features, such as any of the techniques or features illustrated and/or described subsequently herein with respect to any or all of the Figures.

As shown, the device 100 can include a processing element 101. The processing element can include or be coupled to one or more memory elements. For example, the device 100 can include one or more memory media (e.g., memory 105), which can include any of a variety of types of memory and can serve any of a variety of functions. For example, memory 105 could be RAM serving as a system memory for processing element 101. Other types and functions are also possible.

Additionally, the device 100 can include wireless communication circuitry 130. The wireless communication circuitry can include any of a variety of communication elements (e.g., antenna(s) for wireless communication, analog and/or digital communication circuitry/controllers, etc.) and can enable the device to wirelessly communicate using one or more wireless communication protocols. In some embodiments, the device 100 can be a multi-link device (MLD), e.g., capable of communicating using multiple different wireless links (e.g., of WLAN and/or other technologies) simultaneously.

Note that in some cases, the wireless communication circuitry 130 can include its own processing element (e.g., a baseband processor), e.g., in addition to the processing element 101. For example, the processing element 101 can be an ‘application processor’ whose primary function can be to support application layer operations in the device 100, while the wireless communication circuitry 130 can be a ‘baseband processor’ whose primary function can be to support baseband layer operations (e.g., to facilitate wireless communication between the device 100 and other devices) in the device 100. In other words, in some cases the device 100 can include multiple processing elements (e.g., can be a multi-processor device). Other configurations (e.g., instead of or in addition to an application processor/baseband processor configuration) utilizing a multi-processor architecture are also possible.

The device 100 can additionally include any of a variety of other components (not shown) for implementing device functionality, depending on the intended functionality of the device 100, which can include further processing and/or memory elements (e.g., audio processing circuitry), one or more power supply elements (which can rely on battery power and/or an external power source) user interface elements (e.g., display, speaker, microphone, camera, keyboard, mouse, touchscreen, etc.), and/or any of various other components.

The components of the device 100, such as processing element 101, memory 105, and wireless communication circuitry 130, can be operatively coupled via one or more interconnection interfaces, which can include any of a variety of types of interface, possibly including a combination of multiple types of interface. As one example, a USB high-speed inter-chip (HSIC) interface can be provided for inter-chip communications between processing elements. Alternatively (and/or in addition), a universal asynchronous receiver transmitter (UART) interface, a serial peripheral interface (SPI), inter-integrated circuit (I2C), system management bus (SMBus), and/or any of a variety of other communication interfaces can be used for communications between various device components. Other types of interfaces (e.g., intra-chip interfaces for communication within processing element 101, peripheral interfaces for communication with peripheral components within or external to device 100, etc.) can also be provided as part of device 100.

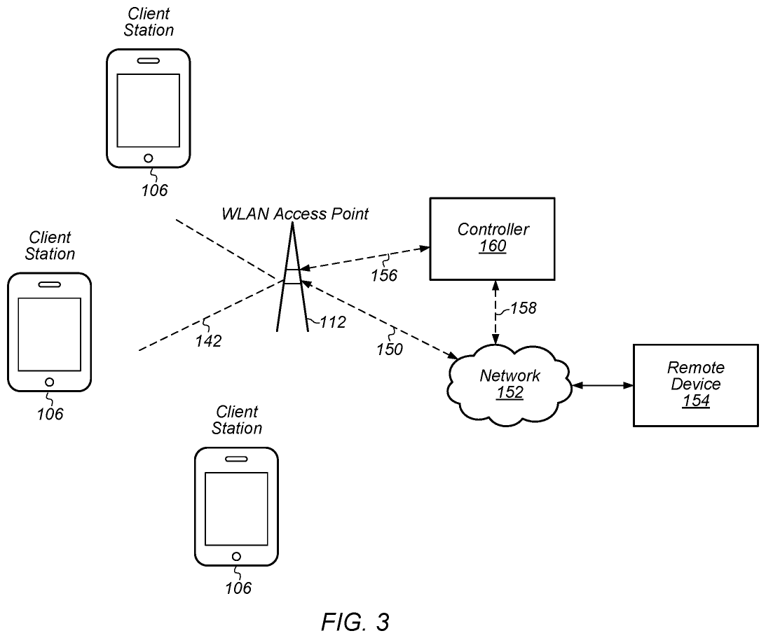

### FIG. 3—WLAN System

FIG. 3 illustrates an example WLAN system according to some embodiments. As shown, the exemplary WLAN system includes a plurality of wireless client stations or devices (e.g., STAs or user equipment (UEs)), 106 that are configured to communicate over a wireless communication channel 142 with an Access Point (AP) 112, e.g., a Wi-Fi (or 802.11) access point. The AP 112 can communicate via a wired and/or a wireless communication channel 150 with one or more other electronic devices (not shown) and/or another network 152, such as the Internet. Additional electronic devices, such as the remote device 154, can communicate with components of the WLAN system via the network 152. For example, the remote device 154 can be another wireless client station, a server associated with an application executing on one of the STAs 106, etc. The WLAN system can be configured to operate according to any of various communications standards, such as the various IEEE 802.11 standards. In some embodiments, at least one wireless device 106 is configured to communicate directly with one or more neighboring mobile devices, without use of the access point 112.

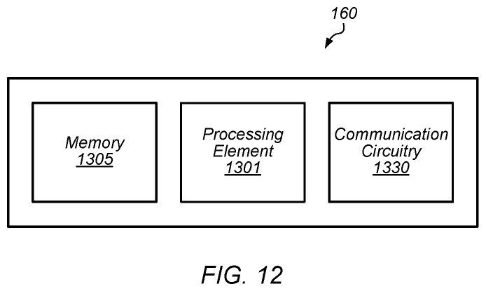

In some embodiments, AP 112 can communicate via a wired and/or a wireless communication channel 156 (and/or a combination of channels 150 and 158) with a controller 160 (see also: FIG. 12). The controller can manage a wireless network (e.g., at an airport, stadium, campus, office, home, or any other facility or location) including one or more APs. The APs can share a common extended service set identifier (ESSID). In some embodiments, the APs can advertise a common service set identifier (SSID) (e.g., “XYZ airport”, etc.). In some embodiments, the controller can be separate from the APs and can communicate with the APs via a direct connection (e.g., 156) and/or via the internet (e.g., via a combination of 150, 152, 158). In some embodiments, the controller can be housed in/with one of the APs and can communicate with the other APs via direct connection (e.g., 156) and/or via the internet (e.g., via a combination of 150, 152, 158).

Further, in some embodiments, a wireless device 106 (which can be an exemplary implementation of device 100) can be configured to perform methods for communication in a manner to reduce/avoid interference due to coexistence while communicating according to multiple RATs.

It will be appreciated that the wireless device 106 and/or AP 112 can be multi-link devices (MLDs). For example, the wireless device 106 and/or AP 112 can use one or multiple links to communicate. For example, such links can include links on a 2.4 GHz band, 5 GHz band, and/or 6 GHz band, among various possibilities. The wireless device can be a non-AP MLD, e.g., with multiple affiliated STAs. The AP can be an AP MLD, e.g., with multiple affiliated APs.

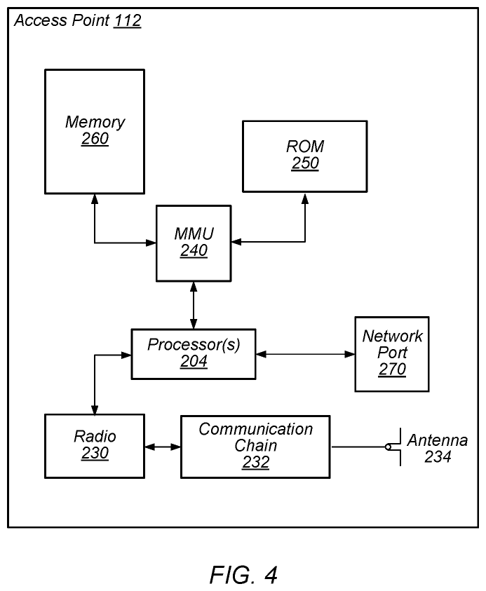

### FIG. 4—Access Point Block Diagram

FIG. 4 illustrates an exemplary block diagram of an access point (AP) 112, which can be one possible exemplary implementation of the device 100 illustrated in FIG. 4. It is noted that the block diagram of the AP of FIG. 4 is only one example of a possible system. As shown, the AP 112 can include processor(s) 204 which can execute program instructions for the AP 112. The processor(s) 204 can also be coupled (directly or indirectly) to memory management unit (MMU) 240, which can be configured to receive addresses from the processor(s) 204 and to translate those addresses to locations in memory (e.g., memory 260 and read only memory (ROM) 250) or to other circuits or devices.

The AP 112 can include at least one network port 270. The network port 270 can be configured to couple to a wired network and provide a plurality of devices, such as mobile devices 106, access to the Internet. For example, the network port 270 (and/or an additional network port) can be configured to couple to a local network, such as a home network or an enterprise network. For example, port 270 can be an Ethernet port. The local network can provide connectivity to additional networks, such as the Internet.

The AP 112 can include at least one antenna 234, which can be configured to operate as a wireless transceiver and can be further configured to communicate with mobile device 106 via wireless communication circuitry 230. The antenna 234 communicates with the wireless communication circuitry 230 via communication chain 232. Communication chain 232 can include one or more receive chains, one or more transmit chains or both. The wireless communication circuitry 230 can be configured to communicate via Wi-Fi or WLAN, e.g., 802.11. The wireless communication circuitry 230 can also, or alternatively, be configured to communicate via various other wireless communication technologies, including, but not limited to, Long-Term Evolution (LTE), LTE Advanced (LTE-A), 5G NR, etc., for example when the AP is co-located with a base station in the case of a small cell, or in other instances when it can be desirable for the AP 112 to communicate via various different wireless communication technologies.

Further, in some embodiments, as further described below, AP 112 can be configured to perform methods for communication with a wireless device (e.g., 106) in a manner to reduce/avoid coexistence interference (e.g., at the wireless device) associated with a different RAT.

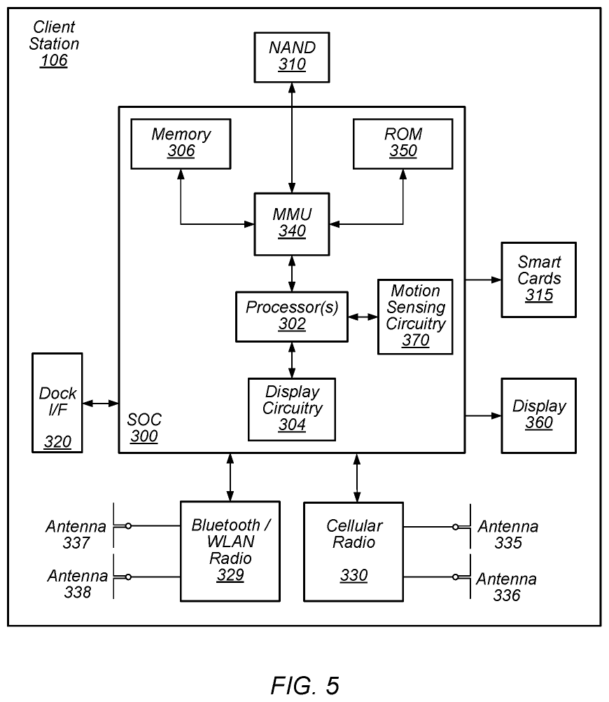

### FIG. 5—Client Station Block Diagram

FIG. 5 illustrates an example simplified block diagram of a client station 106, which can be one possible exemplary implementation of the device 100 illustrated in FIG. 4. According to embodiments, client station 106 can be a user equipment (UE) device, a mobile device or mobile station, and/or a wireless device or wireless station. As shown, the client station 106 can include a system on chip (SOC) 300, which can include portions for various purposes. The SOC 300 can be coupled to various other circuits of the client station 106. For example, the client station 106 can include various types of memory (e.g., including NAND flash 310), a connector interface (I/F) (and/or dock) 320 (e.g., for coupling to a computer system, dock, charging station, etc.), the display 360, cellular communication circuitry (e.g., cellular radio) 330 such as for 5G NR, LTE, etc., and short to medium range wireless communication circuitry (e.g., Bluetooth™/WLAN radio) 329 (e.g., Bluetooth™ and WLAN circuitry). The client station 106 can further include one or more smart cards 315 that incorporate SIM (Subscriber Identity Module) functionality, such as one or more UICC(s) (Universal Integrated Circuit Card(s)). The cellular communication circuitry 330 can couple to one or more antennas, such as antennas 335 and 336 as shown. The short to medium range wireless communication circuitry 329 can also couple to one or more antennas, such as antennas 337 and 338 as shown. Alternatively, the short to medium range wireless communication circuitry 329 can couple to the antennas 335 and 336 in addition to, or instead of, coupling to the antennas 337 and 338. The short to medium range wireless communication circuitry 329 can include multiple receive chains and/or multiple transmit chains for receiving and/or transmitting multiple spatial streams, such as in a multiple-input multiple output (MIMO) configuration. Some or all components of the short to medium range wireless communication circuitry 329 and/or the cellular communication circuitry 330 can be used for wireless communications, e.g., using WLAN, Bluetooth, and/or cellular communications.

As shown, the SOC 300 can include processor(s) 302, which can execute program instructions for the client station 106 and display circuitry 304, which can perform graphics processing and provide display signals to the display 360. The SOC 300 can also include motion sensing circuitry 370 which can detect motion of the client station 106, for example using a gyroscope, accelerometer, and/or any of various other motion sensing components. The processor(s) 302 can also be coupled to memory management unit (MMU) 340, which can be configured to receive addresses from the processor(s) 302 and translate those addresses to locations in memory (e.g., memory 306, read only memory (ROM) 350, NAND flash memory 310) and/or to other circuits or devices, such as the display circuitry 304, cellular communication circuitry 330, short range wireless communication circuitry 329, connector interface (I/F) 320, and/or display 360. The MMU 340 can be configured to perform memory protection and page table translation or set up. In some embodiments, the MMU 340 can be included as a portion of the processor(s) 302.

As noted above, the client station 106 can be configured to communicate wirelessly directly with one or more neighboring client stations. The client station 106 can be configured to communicate according to a WLAN RAT for communication in a WLAN network, such as that shown in FIG. 3 or in FIG. 1.

As described herein, the client station 106 can include hardware and software components for implementing the features described herein. For example, the processor 302 of the client station 106 can be configured to implement part or all of the features described herein, e.g., by executing program instructions stored on a memory medium (e.g., a non-transitory computer-readable memory medium). Alternatively (and/or in addition), processor 302 can be configured as a programmable hardware element, such as an FPGA (Field Programmable Gate Array), or as an ASIC (Application Specific Integrated Circuit). Alternatively (and/or in addition) the processor 302 of the UE 106, in conjunction with one or more of the other components 300, 304, 306, 310, 315, 320,329, 330, 335, 336, 337, 338, 340, 350, 360, 370 can be configured to implement part or all of the features described herein.

In addition, as described herein, processor 302 can include one or more processing elements. Thus, processor 302 can include one or more integrated circuits (ICs) that are configured to perform the functions of processor 302. In addition, each integrated circuit can include circuitry (e.g., first circuitry, second circuitry, etc.) configured to perform the functions of processor(s) 204.

Further, as described herein, cellular communication circuitry 330 and short-range wireless communication circuitry 329 can each include one or more processing elements. In other words, one or more processing elements can be included in cellular communication circuitry 330 and also in short range wireless communication circuitry 329. Thus, each of cellular communication circuitry 330 and short-range wireless communication circuitry 329 can include one or more integrated circuits (ICs) that are configured to perform the functions of cellular communication circuitry 330 and short-range wireless communication circuitry 329, respectively. In addition, each integrated circuit can include circuitry (e.g., first circuitry, second circuitry, etc.) configured to perform the functions of cellular communication circuitry 330 and short-range wireless communication circuitry 329.

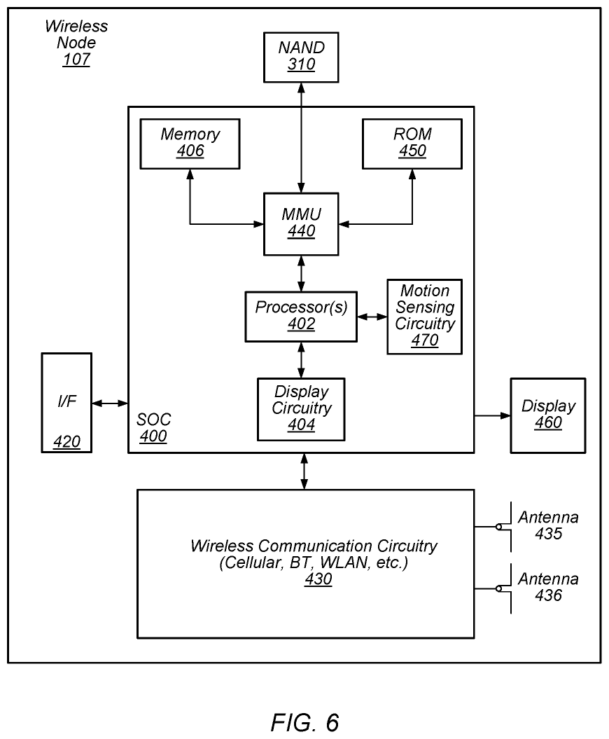

### FIG. 6—Wireless Node Block Diagram

FIG. 6 illustrates an example block diagram of a wireless node 107, which represents an exemplary implementation of the device 106 illustrated in FIG. 5. As shown, the wireless node 107 can include a system on chip (SOC) 400, which can include portions for various purposes. For example, as shown, the SOC 400 can include processor(s) 402 which can execute program instructions for the wireless node 107, and display circuitry 404 which can perform graphics processing and provide display signals to the display 460. The SOC 400 can also include motion sensing circuitry 470 which can detect motion of the wireless node 107, for example using a gyroscope, accelerometer, and/or any of various other motion sensing components. The processor(s) 402 can also be coupled to memory management unit (MMU) 440, which can be configured to receive addresses from the processor(s) 402 and translate those addresses to locations in memory (e.g., memory 406, read only memory (ROM) 450, flash memory 410). The MMU 440 can be configured to perform memory protection and page table translation or set up. In some embodiments, the MMU 440 can be included as a portion of the processor(s) 402.

As shown, the SOC 400 can be coupled to various other circuits of the wireless node 107. For example, the wireless node 107 can include various types of memory (e.g., including NAND flash 410), a connector interface 420 (e.g., for coupling to a computer system, dock, charging station, etc.), the display 460, and wireless communication circuitry 430 (e.g., for 5G NR, LTE, LTE-A, Bluetooth, Wi-Fi, NFC, GPS, etc.).

The wireless node 107 can include at least one antenna, and in some embodiments, multiple antennas 435 and 436, for performing wireless communication with access points and/or other devices. For example, the wireless node 107 can use antennas 435 and 436 to perform the wireless communication. As noted above, the wireless node 107 can in some embodiments be configured to communicate wirelessly using a plurality of wireless communication standards or radio access technologies (RATs).

The wireless communication circuitry 430 can include one or more logics, SOCs, modules, ICs, and/or processors etc. This circuitry can enable the wireless node 107 to perform Wi-Fi communications, e.g., on an 802.11 network. This circuitry can enable the wireless node 107 to perform Bluetooth communications. This circuitry can enable the wireless node to perform cellular communication according to one or more cellular communication technologies. Some or all components of the wireless communication circuitry 430 can be used for wireless communications, e.g., using WLAN, Bluetooth, and/or cellular communications.

As described herein, wireless node 107 can include hardware and software components for implementing embodiments of this disclosure. For example, one or more components of the wireless communication circuitry 430 (e.g., Wi-Fi Logic 432) of the wireless node 107 can be configured to implement part or all of the methods described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

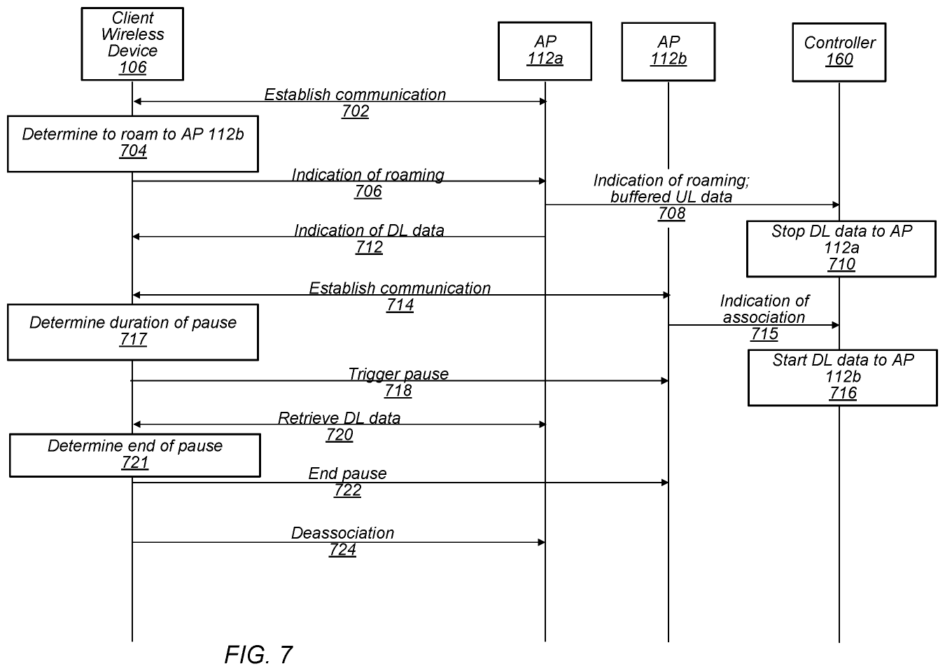

### FIG. 7—Enhanced Roaming

Fast roaming (also known as layer 2 (L2) roaming) can be standardized in an IEEE 802.11 specification, such as 802.11r. According to fast roaming techniques, a client wireless device (“client”) determines to roam from one AP (e.g., of a network with multiple APs) to another AP (e.g., of the same network). In existing fast roaming techniques, the client can not notify its current serving AP about its intent to roam. Furthermore, the current serving AP does not know when or if the client has left its basic service set (BSS).

As one result of the conventional techniques, when a client performs an L2 roam (e.g., L2 handover) from an AP1 to an AP2, it is possible that downlink (DL) packets that get buffered at AP1 while the client is executing the L2 roam with AP2 can be lost, if the L2 roam with AP2 is successful. On the other hand, if the L2 roam with AP2 fails, the buffered packets at AP1 ultimately can be received by the client, but with an additional delay. These behaviors can result in QoS issues with one or more real-time applications, such as video conferencing, streaming audio, etc. For example, buffered packet loss or additional delay in packet delivery can cause problems such as audio erasure, video stall, etc.

Embodiments described herein provide techniques that can be used to reduce or avoid such packet loss, delay, and/or other issues associated with a client roaming between APs. For example, the techniques herein can reduce or avoid packet loss and/or any additional latency in fetching buffered packets during an L2 roam procedure. For example, a client can retrieve DL data from the serving (e.g., source) AP after associating with a new (e.g., target) AP. Methods described herein can prevent or reduce the loss of data (e.g., packets buffered at the source AP) and/or latency. As a result, these methods can improve user experience by ameliorating data loss and/or latency and the associated impacts (e.g., video stall, audio erasure, etc.). Example implementations of new signaling to facilitate the methods are also described.

Aspects of the method of FIG. 7 can be implemented by one or more APs in communication with a wireless device (e.g., STA, client) and/or a controller associated with multiple APs. The AP, wireless device, and/or controller can be as illustrated in and described with respect to various ones of the Figures herein, or more generally in conjunction with any of the computer circuitry, systems, devices, elements, or components shown in the above Figures, among others, as desired. For example, a processor (and/or other hardware) of such a device can be configured to cause the device to perform any element or combination of illustrated method elements and/or other method elements. For example, one or more processors (or processing elements) (e.g., processor(s) 101, 204, 302, 402, 432, 434, 439, 1301, baseband processor(s), processor(s) associated with communication circuitry such as 130, 230, 232, 329, 330, 430, 1330, etc., among various possibilities) can cause a wireless device, STA, UE, controller, and/or AP, or other device to perform such method element(s).

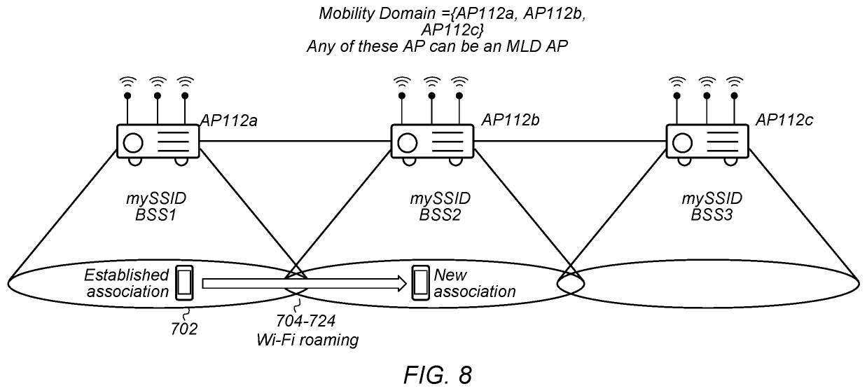

FIG. 8 illustrates an example roaming situation in which methods of FIG. 7 can be applied, according to some embodiments. As shown, a mobility domain (e.g., roaming set) can include APs 112a, 112b, and 112c. These APs can be managed by a controller 160 (not shown in FIG. 8) and can be wired and/or wirelessly connected to the controller 160. The APs in the mobility domain can belong to a same network (e.g., a distribution system (DS) with a common extended SSID (ESSID). The APs in the mobility domain can all advertise/use a common SSID (e.g., “mySSID”). For example, the APs in the mobility domain can be located in a facility (such as an airport, enterprise, campus, etc.) and the common SSID can be associated with that facility. Each of the APs can use its own BSS, according to some embodiments. At 702, the client device has an established association with AP 112a using BSS1. As the client moves, it can reassociate with one or more new APs. Note that, in some implementations, a reassociation process can operate as follows. The client can execute an 802.11r fast roam that includes the following exchange with new AP: 1) authorization request (from client to new AP); 2) authorization response; 3) reassociation request (client to new AP); and 4) reassociation response.

Note that while at least some elements of the method of FIG. 7 are described in a manner relating to the use of communication techniques and/or features associated with IEEE 802.11 (e.g., 802.11r, 802.11be, 802.11bx, Wi-Fi 8, etc.) specification documents, such description is not intended to be limiting to the disclosure, and aspects of the method of FIG. 7 can be used in any suitable wireless communication system, as desired.

The methods shown can be used in conjunction with any of the systems, methods, or devices shown in the Figures, among other devices. In various embodiments, some of the method elements shown can be performed concurrently, in a different order than shown, or can be omitted. Additional method elements can also be performed as desired. As shown, this method can operate as follows.

A client wireless device 106 establishes first communication with a serving AP 112a (702), according to some embodiments. The serving AP can be one of a plurality of APs (e.g., a mobility domain with a common distribution system) managed by a controller 160, including at least AP 112b. The communication can be wireless communication according to an 802.11 standard.

The client 106 determines to roam (e.g., switch) to AP 112b (704), according to some embodiments. For example, the client can perform signal strength measurements (e.g., RSSI, SNR, SINR, etc.) and/or measure other characteristics of AP 112a and/or AP 112b. The client can determine to roam to AP 112b based on one or more of the measurements. For example, the client can compare the measurement(s) to corresponding threshold(s) to determine whether to roam. For example, the determination to roam can be based on a measurement of signal strength of AP 112a falling below a first threshold, a measurement of signal strength of AP 112b exceeding a second threshold (e.g., or exceeding the strength of 112a), etc. The determination can be based on other or additional factors, such as location and/or motion of the client, past associations with the APs, etc.

In the example of FIG. 8, this determination to roam occurs in or near an area of overlap between the coverage areas of serving AP 112a and target AP 112b, according to some embodiments.

The client device transmits a roaming indication to the serving AP 112a (706), according to some embodiments. The roaming indication can be transmitted in response to the determination to roam (e.g., 704). Various types of frames/messages can be used to provide the roaming indication.

In some embodiments, the roaming indication signals to the serving AP to clear an uplink reorder buffer of any pending uplink data of the client. In other words, the indication can inform the serving AP that the client intends to discontinue use of the serving AP for UL traffic and will use a different AP for further UL traffic.

In some embodiments, the indication can be or include a power management (PM) bit set to a predetermined value, e.g., 1, (or otherwise indicating to at least temporarily disable the link(s) with the serving AP 112a). In some embodiments, the client can use a block acknowledgement request (BAR) with the PM bit set to a predetermined value, e.g., 1, for the indication.

An MLD client device can indicate that the AP 112a is to deactivate one or more links with the MLD client (e.g., potentially leaving one or more other links active between the MLD client and AP 112a).

Thus, a non-MLD client can disable the (e.g., one) link with AP 112a. An MLD client can use link-specific signaling to indicate which specific link(s) (if any) to disable. For example, in some implementations, an MLD client can use a BAR with PM=1 for any link(s) to be disabled and PM=0 for any link(s) to remain active. Other signaling mechanisms can be used in other implementations.

It will be appreciated that PM bit setting in control frames can not be common and can indicate special behavior occurrence, according to some embodiments.

In some embodiments, a new type of frame is used to provide the indication. Such a new type of frame can include any combination of the information discussed above with respect to the indication (e.g., 706).

The AP 112a can receive the roaming indication.

The AP 112a transmits a further roaming indication to the controller 160 (708), according to some embodiments. The further roaming indication can be responsive to receiving the roaming indication from the client and can include any or all of the information included in the client's roaming indication (e.g., of 706).

Additionally or alternatively, the AP 112a can clear its UL reordering buffer associated with the client 106. In other words, the AP 112a can transmit any UL data that it has received from the client. The AP 112a can transmit such data to the controller and/or to other components of the distribution set for onward transmission toward the appropriate destination device(s). Notably, in some implementations, the AP 112a can transmit such data in response to the roaming indication without waiting for any missing packets. This can reduce latency associated with roaming. Moreover, this can avoid ambiguity about the data path to the client to/from DS. For example, clearing the reorder buffer can ensure AP 112a will forward all UL packets to the gateway (e.g., DS). Then any new UL packets from the client will be forwarded by AP 112b to the gateway (or DS).

The controller adjusts delivery of DL data for the client (710), according to some embodiments. For example, the controller can pause or discontinue providing downlink data for the client to the AP 112a. Instead, the controller can buffer this data locally for transmission after the roaming attempt is resolved (e.g., via the AP 112b if roaming is successful or via AP 112a if roaming is unsuccessful).

In some embodiments, instead of (or in addition to) the controller buffering downlink data for the client, the downlink data can be provided to the target AP 112b for transmission after the roaming attempt is resolved (e.g., via the AP 112b if roaming is successful or by returning it to the AP 112a for transmission to the client if roaming is unsuccessful).

The AP 112a transmits to the client 106 an indication of an amount of DL data pending for the client in the AP's buffer (712), according to some embodiments. For example, the AP 112a can provide one or more buffer status report poll (BSRP) responses. The indication can be transmitted in response to a query (e.g., a BSRP) from the client (e.g., separate from 706) or in response to the roaming indication (e.g., 706). It will be appreciated that, in some other implementations, the indication 712 can occur at other times (e.g., between 706 and 715, among various possibilities). Further, multiple roaming indications can be sent (e.g., including while 720 is ongoing, etc.) as the amount of pending data can change. Further, a single BSRP can be used to trigger more than one BSRP response. For example, in response to a BSRP associated with a roaming event (e.g., prior to or during a pause as discussed with respect to 717-722), the AP 112a can transmit multiple BSRP responses. Such responses can be transmitted periodically, or in response to certain amounts of DL data remaining, etc. In some implementations, such responses can mimic unsolicited BSRP response behavior.

The client and target AP 112b establish communication (714), according to some embodiments.

In the case of an MLD client, the client can establish communication with the target AP 112b using one or more links. One or more other links of the client can continue to be used with the source AP 112a, according to some embodiments.

In some embodiments, the client sends a message to update the data plane to/from the DS. This can be transmitted during the association (e.g., in an association frame) or subsequent to the association.

The AP 112b indicates to the controller 160 that communication with the client is established (715), according to some embodiments. The controller can thus determine that the roaming attempt is successful. In some embodiments, the controller and/or AP 112b can inform the source AP 112a of the successful roaming operation.

The controller adjusts DL transmission for the client (716), according to some embodiments. For example, the controller can provide any downlink data buffered at the controller to the AP 112b. Further, the controller can cause any subsequently received DL data for the client to be forwarded to the AP 112b for transmission to the client. The adjustment can be in response to a determination that the AP 112b and the client have established communication (e.g., that roaming is successful).

The client determines whether to initiate a pause (e.g., timeout) in DL data from AP 112b and, if a pause is to be initiated, can determine a requested duration (717), according to some embodiments. For example, a non-MLD client or an MLD client that is either not capable of operating relevant different links simultaneously can determine to initiate a pause. Note that for purposes of this discussion of 717, capability of simultaneous operation of the links can include capability to reorder packets received on the various links as needed.

In some embodiments, even if the client determines to initiate a pause, no duration is determined in advance. Instead, an end time to the pause can be indicated at a later time (e.g., 722).

In some embodiments, a requested duration of pause is based on an amount of data to retrieve from AP 112a. For example, based on information from the AP 112a (e.g., 712) and/or the client's own estimate, the client can determine an amount of data to be retrieved. Based on the amount of data, the client can estimate a time requirement and can use the estimated time requirement (possibly with a padded margin and/or subject to a cap) as the requested duration. The time estimate can further be based on a data rate (e.g., of the link(s) with the AP 112a), such as a measured, averaged, or projected rate.

In some embodiments, a default duration of pause is set (e.g., in a wireless standard or by the controller, etc.). The default duration can be used (e.g., and thus no estimation or indication of the amount of data (e.g., 712) can be performed). In some embodiments, even when a default is set, a determination of an estimated time requitement can be performed and the client can select whether to request the default or a duration based on the estimate.

If a pause is to be initiated, the client can transmit, to the AP 112b, a message triggering the pause (718), according to some embodiments. For example, the message can be an indication to pause downlink traffic to the client for a first period of time while uplink traffic from the client to the AP 112b is not paused for the first period of time. In some embodiments, the message can indicate a requested duration for the pause. In some embodiments, no duration can be indicated for the pause and a default duration can be used. In some embodiments, the AP 112b and client can exchange one or more messages to negotiate a pause duration. In some embodiments, no pause duration can be indicated and an end time for the pause can be indicated, e.g., at a later time (e.g., 722).

In some embodiments, the indication to pause downlink traffic to the client is to be included in an association (e.g., initial association or reassociation) frame or message (e.g., as can be used in an initial association or reassociation process).

For example, a one bit field in an association frame can be used to indicate that a pause in DL traffic is requested. If such a one bit field is used, it can be interpreted to request the pause to start immediately or after a pre-determined offset, e.g., from the time of association, the time of transmission, etc. Such a pre-determined offset can be specified in a wireless standard and/or by the controller. Further, if such a one bit field is used, it can be interpreted to request the pause to be of predetermined amount of time, e.g., a default duration or for an indefinite duration (e.g., until an end is requested in 722). The interpretation of the duration can be as specified in a wireless standard and/or by the controller. In other implementations, a different number of bits can be used to signal the pause request and/or duration.

The indication can be common to all traffic identifiers (TIDs) or can be TID specific. An indication can comprise one or more TID specific indications (e.g., of one bit per TID or one bit for all TIDs, among various possibilities). The indication can be transmitted in an association frame, among various possibilities.

In some embodiments, the indication can comprise a one (or more than one) bit indication in an operating mode indication (OMI) field of a frame. Such a frame can be an association frame (e.g., as can be used in 714), or any other control frame, data frame, or management frame.

In some embodiments, the indication can comprise one or more TID-to-link mapping information elements (IEs). For example, such an IE can map DL traffic to some special value reserved to indicate a pause in the traffic. The IE can map UL traffic to one or more active links (e.g., to be used by the client for transmitting UL traffic to the AP 112b). Such an approach can be used by an MLD client, among various possibilities.

The AP 112b can receive the indication and can begin to pause DL traffic delivery to the client at the start time of the pause. During the pause, the AP 112b can buffer DL traffic for the client at the AP 112b. Storing DL data at the AP 112b can avoid DL out-of-order delivery. However, the AP 112b can continue to accept UL data from the client, and thus can avoid additional latency for such traffic.

The client 106 retrieves DL data from the source AP 112a (720), according to some embodiments. This retrieval can occur during the pause, if a pause is initiated.

In some embodiments, the client transmits a message to the AP 112a to trigger the AP 112a to initiate transmission of any DL data stored in the buffer of AP 112a for the client. For example, the client (e.g., a non-MLD) can set a PM bit, e.g., to 0, for the AP 112a, thus causing the AP 112a to reactivate communication with the client and transmit DL data.

In some embodiments, a triggering message can not be used. For example, an MLD client can leave a first link active for DL with the AP 112a while establishing communication (e.g., for UL) with the AP 112b using a second link. Thus, in such a case, the AP 112a can transmit the remaining DL data to the client using the first link without communication of a triggering message.

In some embodiments, AP 112a waits for the pause to begin prior to transmitting the DL data (e.g., without an explicit triggering message from the client). For example, the pause can occur at a preset time (e.g., an offset from 706, 714 or 718). The AP 112b and/or controller can inform the AP 112a when the pause is to begin (e.g., or when 714 of 718 occurs). In such implementations, the AP 112a can be able to determine when the client is ready to receive the DL data without receiving a triggering message from the client.

While the DL data is being communicated from AP 112a, an MLD client can ensure that only 1 data plane to/from the DS is active at any given time.

During the pause, a radio of a non-MLD client can be time-shared between AP 112a and AP 112b. Similarly, an MLD client can duty cycle between a first link with AP 112a and a second link with AP 112b, e.g., if both links cannot operate simultaneously.

In some embodiments, an MLD client triggers the pause on only a subset of links active with the AP 112b. For example, a first link can be paused while a second link is not.

In some embodiments, the client can determine when to end the pause, e.g., or to modify/update a requested duration of the pause (721).

As one possibility, if the pause is initiated with an indefinite duration, the client can determine to end the pause when all DL data has been received from the AP 112a. The determination that all DL data has been received can be based on a reported amount of data (e.g., 712), an expected amount of data, an indication that no more data is buffered, and/or ceasing to receive further DL traffic from the AP 112a.

When the pause is initiated with a finite duration, the client can determine to end the pause early once all DL data has been received from the AP 112a. Further, if additional time is needed to receive all DL data (e.g., based on the same factors as can be used to determine that the retrieval is complete), the client can determine to request to delay the end of the pause or to otherwise extend the pause.

In some embodiments, the client requests that the AP 112a provide one or more updates (e.g., buffer status report(s)) on the amount of DL data remaining. The client can use such updates to inform its determination of when to end the pause. In some embodiments, the AP 112a can provide one or more updates automatically, e.g., without a request from the client.

As another possibility, the client can determine to end the pause based on one or more measurements (e.g., signal strength) associated with the AP 112a, e.g., in comparison to a threshold(s).

The client transmits a message to the AP 112b to end the pause (722), according to some embodiments. The message can use a similar format to any of those discussed above with respect to 718, according to some embodiments. For example, an OMI field or TID-to-link mapping IE can be used. In the case of a TID-to-link mapping IE, the client can indicate the DL (and possibly UL) TIDs it proposes to map to one or more respective links. Further, in some implementations, the client can not use a special value for pausing DL.

Note that in some cases as noted above, no pause can be used or a pause of a defined duration can be used. In such cases, no message ending the pause need be used, according to some embodiments. For example, if a pause of a definite duration is used, the AP 112b and client can each be able to determine the end of the pause without signaling for this purpose. In other words, timeout-based behavior can be used (e.g., the client and AP 112b can each operate based on a pause of the pre-determined duration).

The client ends the association (e.g., disassociate) with the source AP 112a (724), according to some embodiments. In some implementations, ending the association (e.g., through disassociation) can be omitted.

Disassociating with AP 112a can provide some advantages. For example, the AP 112a can thus clear resources consumed by the client upon disassociation, potentially returning those resources to AP 112a sooner. However, in some instances, a disassociation frame can necessitate one or more retries (e.g., as the client can be moving away from AP 112a), which consume network resources. Also, spending more time with AP 112a to affirmatively perform disassociation can penalize DL traffic arrival from new AP 112b, e.g., in a non-MLD client. Thus, in some circumstances it can not be efficient to complete the disassociation.

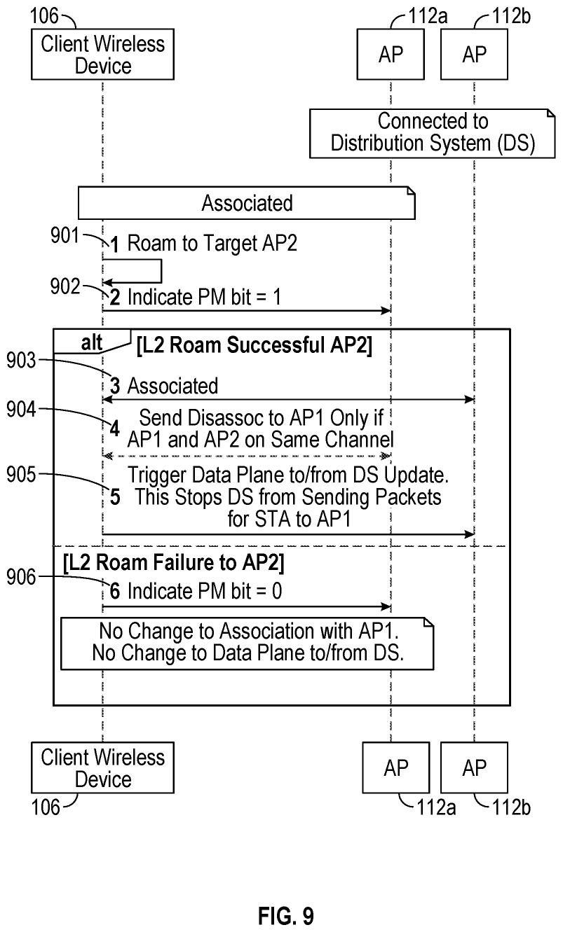

### FIG. 9

FIG. 9 illustrates an example communication flow associated with roaming, according to some embodiments. On association, AP 112a can update the DS that the data plane to/from client 106 is through AP 112a. The client can determine to roam (901) and can set the PM bit to a predetermined value, e.g., to 1, for AP 112a (902).

In the case of a successful roam, the client can associate (903) with AP 112b. The client can send a disassociation message to the AP 112a (904), according to some embodiments. The client can trigger (e.g., through a gratuitous automatic response protocol (ARP) message) the AP 112b to perform a data plane update in the DS (905) to prevent (or reduce the chance for) future packets from the DS from being delivered to the incorrect AP (e.g., AP 112a in this example). However, under a conventional process, packets previously delivered to AP 112a can not be re-routed or delivered. Thus, buffered packet loss at AP 112a can occur when the L2 roam operation is successful. Further, this scenario can lead to unnecessary resource usage by AP 112a (e.g., AP 112a can be unaware that STA is gone due to the L2 roam success, and can thus waste resources dedicated to the client rather than redeploying these resources). As discussed above, aspects of the method of FIG. 7 can prevent such unnecessary resource usage.

In the case of an unsuccessful roam operation, the client resets the PM bit to a predetermined value, e.g., 0, with AP 112a (906), according to some embodiments. In the instance of an unsuccessful roam operation, additional latency in receiving buffered packets from AP 112a can occur.

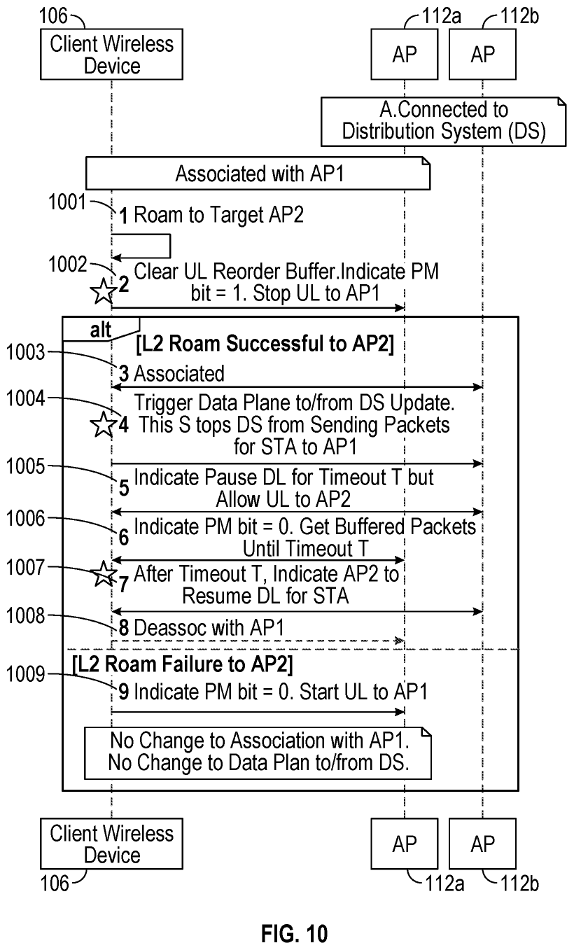

### FIG. 10

FIG. 10 illustrates an example communication flow associated with roaming, according to some embodiments of the methods of FIG. 7. In the case of FIG. 10, the client can be a non-MLD wireless device. In this example, after associating with target AP 112b, the client can continue communicating with AP 112a to receive one or more remaining buffered packets. This continued communication can be for a limited time.

On association, AP 112a can update the DS to indicate that the data plane to/from client 106 is through AP 112a. Subsequently, the client determines to roam (1001) and/or sets the PM bit to a predetermined value, e.g., 1, for AP 112a (1002), according to some embodiments.

In the case of a successful roam, the client associates (1003) with AP 112b. The client can trigger (e.g., through a gratuitous ARP message) the AP 112b to perform a data plane update in the DS (1004), according to some embodiments. As a result, future packets from the DS will not be delivered to the wrong AP (e.g., 112a).

The client indicates to AP 112b to pause DL transmissions for a timeout period T (1005), according to some embodiments. During the pause, the AP 112b will not deliver DL packets to the client, but can continue to accept UL packets from the client. Thus, an UL delay can be avoided during the period T. During the pause, the client can time share its radio and related circuitry/hardware/processors. For example, the client can trigger the AP 112a to deliver one or more buffered DL packets (1006) or the AP 112a can do so independently. Thus, buffered packet loss as a result of the roaming operation can be avoided. However, some delay in receiving the buffered DL packets from AP 112a can be experienced. Further, the client can indicate for the AP 112b to initiate (or resume) DL delivery (1007) of packets, e.g., after timeout period T. Alternatively, the AP 112b can independently initiate or resume DL packet delivery, e.g., after timeout period T. The client can send a disassociation message to the AP 112a (1008) or can elect not to do so, according to various embodiments.

In the case of an unsuccessful roam, the client resets the PM bit to a predetermined value, e.g., 0, with AP 112a (1009), according to some embodiments.

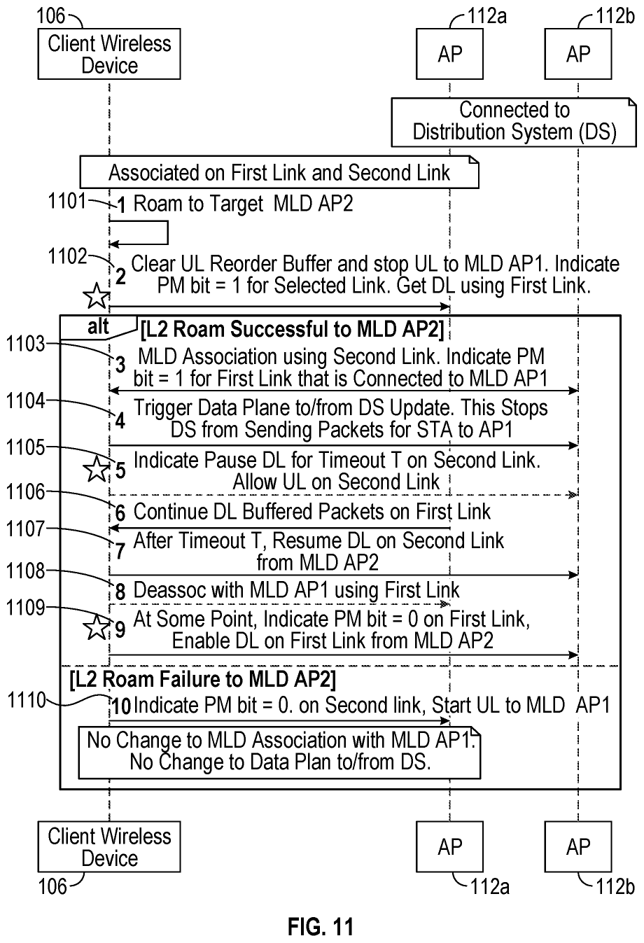

### FIG. 11

FIG. 11 illustrates an example communication flow associated with roaming, e.g., according to some embodiments of the methods of FIG. 7. In the case of FIG. 11, the client is an MLD wireless device. In such embodiments, after associating with target MLD AP 112b, the client can receive one or more buffered packets from MLD AP 112a. It will be appreciated that the MLD AP 112a and MLD AP 112b can belong to two non-affiliated MLD APs.

On association, MLD AP 112a can update the DS to indicate that the data plane to/from client 106 is through MLD AP 112a. Subsequently, the client can determine to roam (1101). The client can continue using a first link with MLD AP 112a and can set the PM bit to a predetermined value, e.g., 1, for a second link with MLD AP 112a (1102). The client can continue using the first link to receive DL packets from MLD AP 112a, and MLD AP 112a can continue accepting UL packets from the client (e.g., using the first link). Further, MLD AP 112a can inform the controller to stop directing DL traffic for the client to MLD AP 112a.

In the case of a successful roam, the client can associate (1103) with MLD AP 112b using the second link. The client can set a PM bit to a predetermined value, e.g., 1, for the first link with MLD AP 112b.

The client triggers (e.g., through a gratuitous ARP message) the MLD AP 112b to perform a data plane update in the DS (1104), according to some embodiments. This can prevent future packets from the DS from being delivered to the incorrect AP (e.g., MLD AP 112a).

The client indicates to MLD AP 112b to pause DL transmissions on the second link for a timeout period T (1105), according to some embodiments. During the pause, the MLD AP 112b can not deliver DL packets to the client, but can continue to accept UL packets from the client using the second link. Thus, an UL delay during the timeout period T can be avoided. During the pause, if the client cannot operate both links simultaneously, the client can time share (e.g., duty cycle) its radio and related circuitry/hardware/processors. The client can continue to receive DL data (packets) from the MLD AP 112a (e.g., one or more previously buffered DL packets) (1106). The client can trigger MLD AP 112a to deliver one or more DL packets or the MLD AP 112a can do so independently. Thus, buffered packet loss as a result of the roaming operation can be avoided, and little or no additional delay for the buffered DL packets can be experienced. After the pause, the client can indicate for the MLD AP 112b to initiate (or resume) DL delivery on the second link (1107) or the AP 112b can do so independently. In some instances, the client can send a disassociation message to the MLD AP 112a (1108). In some other instances, the client can elect not to send a disassociation message to the MLD AP 112a. Further, the client can set a PM bit to a predetermined value, e.g., 0, for the first link with the MLD AP 112b and enable DL on that link (1109), according to some embodiments. This can occur at any time after the first link is no longer in use with MLD AP 112a.

It will be appreciated that the client can use more than 2 links. Any additional link(s) can be allocated to either or both of the APs at any time(s) during the transition from MLD AP 112a to MLD AP 112b. For example, one or more additional links can be moved and activated along with the first link, and one or more other additional links can be moved and activated along with the second link, or vice versa.

In the case of an unsuccessful roam, the client resets the PM bit to a predetermined value, e.g., 0, with AP 112a (1110), according to some embodiments.

### FIG. 12

FIG. 12 illustrates a controller 160 that can be configured for use in conjunction with various aspects of the present disclosure, according to some embodiments. The controller 160 can be any of a variety of types of device and can be configured to perform any of a variety of types of functionality. The controller 160 can be a substantially portable device or can be a substantially stationary device, potentially including any of a variety of types of device. The controller 160 can be configured to perform one or more wireless communication techniques or features, such as any of the techniques or features illustrated and/or described subsequently herein with respect to any or all of the Figures. The controller 160 can be housed in or with an AP 112 or can be housed separately.

As shown, the controller 160 can include a processing element 1301. The processing element can include or be coupled to one or more memory elements. For example, the controller 160 can include one or more memory media (e.g., memory 1305), which can include any of a variety of types of memory and can serve any of a variety of functions. For example, memory 1305 could be RAM serving as a system memory for processing element 1301. Other types and functions are also possible.

Additionally, the controller 160 can include wired and/or wireless communication circuitry 1330. The communication circuitry can include any of a variety of communication elements (e.g., antenna(s) for wireless communication, analog and/or digital communication circuitry/controllers, etc.) and can enable the device to communicate using one or more (e.g., wired and/or wireless) communication protocols.

The controller 160 can use communication circuitry 1330 to communicate with any number of APs (e.g., managed/controlled by controller 160) and/or the internet. In some embodiments, the APs managed/controlled by controller 160 can share a common identifier, e.g., an extended service set identifier (ESSID). The controller 160 can manage a network of APs, e.g., in an airport, campus, hospital, etc.

The controller 160 can additionally include any of a variety of other components (not shown) for implementing device functionality, depending on the intended functionality of the controller 160, which can include further processing and/or memory elements, one or more power supply elements (which can rely on battery power and/or an external power source) user interface elements (e.g., display, speaker, microphone, camera, keyboard, mouse, touchscreen, etc.), and/or any of various other components.

The components of the controller 160, such as processing element 1301, memory 1305, and communication circuitry 1330, can be operatively coupled via one or more interconnection interfaces, which can include any of a variety of types of interface, possibly including a combination of multiple types of interface. As one example, a USB high-speed inter-chip (HSIC) interface can be provided for inter-chip communications between processing elements. Alternatively (and/or in addition), a universal asynchronous receiver transmitter (UART) interface, a serial peripheral interface (SPI), inter-integrated circuit (I2C), system management bus (SMBus), and/or any of a variety of other communication interfaces can be used for communications between various device components. Other types of interfaces (e.g., intra-chip interfaces for communication within processing element 1301, peripheral interfaces for communication with peripheral components within or external to controller 160, etc.) can also be provided as part of controller 160.

### Additional Information and Examples

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In one set of embodiments, a method can comprise: at a wireless device: communicating with a first access point (AP), wherein the first AP is associated with a first group of APs managed by a controller. The method can further comprise determining to roam from the first AP to a second AP among the first group of APs, and in response to the determination to roam: transmitting, to the first AP, a first indication, wherein the first indication sets a power management (PM) bit to 1; and associating with the second AP. The method can further comprise, subsequently to associating with the second AP, transmitting, to the second AP, a second indication, wherein the second indication indicates to pause downlink traffic to the wireless device for a first period of time while uplink traffic from the wireless device to the second AP is not paused for the first period of time. The method can further comprise, during the first period of time, receiving, from the first AP, first downlink data. The method can further comprise, subsequently to the first period of time, receiving, from the second AP, second downlink data.

In some embodiments, the method can further comprise subsequently to receiving the first downlink data, transmitting, to the second AP, a third indication, wherein the third indication indicates to resume downlink traffic to the wireless device.

In some embodiments, the method can further comprise subsequently to transmitting the third indication, disassociating with the first AP.

In some embodiments, the third indication comprises a 1 bit flag in one of a control frame, data frame, or management frame.

In some embodiments, the method can further comprise, during the first period of time, transmitting, to the first AP, a fourth indication to cause the first AP to transmit the first downlink data.

In some embodiments, the fourth indication comprises the PM bit set to 0.

In some embodiments, the first indication comprises a block acknowledgement request with the PM bit set to 1.

In some embodiments, the method can further comprise during the first period of time, transmitting, to the second AP, first uplink data.

In some embodiments, the wireless device is a non-multi-link device; and a radio of the wireless device is time shared between the first AP and the second AP during the first period of time.

In some embodiments, the method can further comprise determining a requested duration of the first period of time based on an estimated amount of time to retrieve the first downlink data from the first AP, wherein the second indication indicates the requested duration.

In some embodiments, the method can further comprise determining that an amount of time to receive the first downlink data is different than a duration of the first period of time; and in response to determining that the amount of time is different than the duration of the first period of time, transmitting, to the second AP a request to adjust the duration of the first period of time.

In some embodiments, the second indication comprises a one bit indication in an association or reassociation frame.

In some embodiments, the second indication comprises one or more one bit traffic identifier (TID) specific indications in an association or reassociation frame.

In some embodiments, the second indication comprises a one bit indication in an operating mode indication (OMI) field of a frame.

In some embodiments, the method can further comprise subsequently to the first period of time, disassociating with the first AP.

In some embodiments, the first indication indicates at least one of: that the first AP is to clear an uplink reorder buffer of any pending uplink data of the wireless device; or that the wireless device will discontinue sending uplink data to the first AP.

In one set of embodiments, a method can comprise: at a wireless device: associating with a first access point (AP), wherein the first AP is associated with a first group of APs managed by a controller; determining to roam from the first AP to a second AP among the first group of APs; in response to the determination to roam: transmitting, to the first AP, a first indication, wherein the first indication indicates: that the first AP is to clear an uplink reorder buffer of any pending uplink data of the wireless device; and deactivating a first link; and associating with the second AP using the first link; during a first period of time, receiving, from the first AP using a second link, first downlink data; and subsequently to the first period of time, receiving, from the second AP using the first link, second downlink data.

In some embodiments, the first indication comprises a block acknowledgement request with a power management bit set to 1.

In some embodiments, the method can further comprise during the first period of time, transmitting, to the second AP, first uplink data using the first link.

In some embodiments, a radio of the wireless multi-link device does not support simultaneous operation of the first link and the second link; the radio is time shared between the first AP and the second AP during the first period of time; and the method further comprises transmitting, to the second AP, a third indication, wherein the third indication indicates to pause downlink traffic to the wireless device for the first period of time.

In some embodiments, the method can further comprise, determining a requested duration of the first period of time based on an estimated amount of time to retrieve the first downlink data from the first AP, wherein the third indication indicates the requested duration.

In some embodiments, the method can further comprise determining that an amount of time to receive the first downlink data is different than a duration of the first period of time; and in response to determining that the amount of time is different than the duration of the first period of time, transmitting, to the second AP a request to adjust the duration of the first period of time.

In some embodiments, the third indication comprises a one bit indication in an association or reassociation frame.

In some embodiments, the third indication comprises one or more one bit traffic identifier (TID) specific indications in an association or reassociation frame.

In some embodiments, the third indication comprises a one bit indication in an operating mode indication (OMI) field of a frame.

In some embodiments, the third indication comprises a traffic identifier (TID) to link mapping information element with a special value for downlink for the first link.

In some embodiments, the method can further comprise, transmitting, to the second AP, a fourth indication to enable downlink data from the second AP on at least one of the first link or the second link.

In some embodiments, the fourth indication comprises a traffic identifier (TID) to link mapping information element with a special value for downlink for the at least one of the first link or the second link.

In some embodiments, the method can further comprise, subsequently to the first period of time, disassociating with the first AP.

In some embodiments, the method can further comprise, subsequently to the first period of time, transmitting to the second AP, a second indication activating the second link.

In one set of embodiments, a method can comprise: at a first access point (AP): communicating with a controller, wherein the first AP is associated with a first group of APs managed by the controller. In some the method can further comprise, communicating with a first wireless device and receiving, from the first wireless device, an indication of roaming. In some embodiments, the method can further comprise, in response to the indication of roaming: clearing an uplink reorder buffer of any pending uplink data of the wireless device; and transmitting, to the controller, an indication to discontinue providing downlink data for the first wireless device to the first AP. In some embodiments, the method can further comprise, transmitting, to the first wireless device, first downlink data, the first downlink data received at the first AP prior to transmitting the indication to discontinue providing downlink data.

In some embodiments, the method can further comprise, waiting to send the first downlink data to the first wireless device until a first period of time begins.

In some embodiments, the method can further comprise, receiving a single buffer status report poll (BSRP) from the first wireless device; and in response to the single BSRP, transmitting a series of BSRP responses to the first wireless device.

In one set of embodiments, a method can comprise: at a second access point (AP): communicating with a controller, wherein the second AP is associated with a first group of APs managed by the controller. In some embodiments, the method can further comprise, communicating with a first wireless device. In some embodiments, the method can further comprise, pausing downlink data transmission to the first wireless device for a first period of time in association with the first wireless device roaming from a first AP among the first group of APs. In some embodiments, the method can further comprise, resuming downlink data transmission to the first wireless device after the first period of time.

In some embodiments, the method can further comprise, exchanging one or more messages with the first wireless device regarding timing or duration of the first period of time.

Any of the methods described herein for operating a wireless device (e.g., client) can be the basis of a corresponding method for operating an AP and vice versa, e.g., by interpreting each message/signal X received by the wireless device in the downlink as message/signal X transmitted by the AP, and each message/signal Y transmitted in the uplink by the wireless device as a message/signal Y received by the AP. Moreover, a method described with respect to an AP can be interpreted as a method for a wireless device in a similar manner. Similarly, any of the methods described above can be interpreted as a method for a controller.

Embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a wireless device can be configured to include a processor (and/or a set of processors) and a memory medium, where the memory medium stores program instructions, where the processor is configured to read and execute the program instructions from the memory medium, where the program instructions are executable to cause the wireless device to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising:
by a wireless device:
communicating with a first access point (AP) associated with a first group of APs;
determining to roam from the first AP to a second AP associated with the first group of APs;
transmitting, to the first AP, a first indication signaling an intent to roam;
associating with the second AP;
transmitting, subsequent to associating with the second AP, a second indication indicating to the second AP to pause downlink traffic to the wireless device for a first period of time;
receiving, during the first period of time, first downlink data from the first AP; and
receiving, subsequent to the first period of time, second downlink data from the second AP.

2. The method of claim 1, further comprising:
subsequent to receiving the first downlink data, transmitting to the second AP, an indication to resume communication of downlink traffic to the wireless device.

3. The method of claim 2, further comprising:
subsequent to transmitting the indication to resume, disassociating with the first AP.

4. The method of claim 2, wherein the indication to resume comprises a one-bit flag in one of: a control frame, a data frame, or a management frame.

5. The method of claim 1, further comprising:
during the first period of time, transmitting to the first AP, a third indication signaling the first AP to transmit the first downlink data.

6. The method of claim 5, wherein the third indication comprises a power management (PM) bit set to 0.

7. The method of claim 1, wherein the first indication comprises a block acknowledgement request with a power management (PM) bit set to 1.

8. The method of claim 1, further comprising:
transmitting, during the first period of time, first uplink data to the second AP.

9. The method of claim 8, further comprising:
time sharing, during the first period of time, a radio of the wireless device between communications with the first AP and communications with the second AP;
wherein the wireless device comprises a non-multi-link device.

10. The method of claim 1, further comprising:
communicating, in the second indication, a requested duration of the first period of time that is based at least on an estimated amount of time to receive the first downlink data from the first AP.

11. A processor configured to perform operations, the operations comprising:
processing messages corresponding to communications on a first link with a first access point (AP) that is associated with a first group of APs;
determining to roam from the first AP to a second AP associated with the first group of APs;
generating a message, to the first AP, comprising a first indication that the first AP can clear an uplink reorder buffer of any pending uplink data associated with the first link and deactivate the first link;
generate a message for associating with the second AP using the first link;
receive, during a first period of time, first downlink data transmitted by the first AP over a second link; and
receive, subsequent to the first period of time, second downlink data transmitted by the second AP over the first link.

12. The processor of claim 11, wherein the first indication comprises a block acknowledgement request with a power management bit set to 1.

13. The processor of claim 11, the operations further comprising:
during the first period of time, transmitting, to the second AP, first uplink data using the first link.

14. The processor of claim 11, wherein:
a radio coupled to the processor does not support simultaneous operation of the first link and the second link;
the radio is time shared between the first AP and the second AP during the first period of time; and
the operations further comprise transmitting, to the second AP, a third indication, wherein the third indication indicates to pause downlink traffic to the radio for the first period of time.

15. The processor of claim 14, further comprising:
determining a requested duration of the first period of time based on an estimated amount of time to retrieve the first downlink data from the first AP, wherein the third indication indicates the requested duration.

16. The processor of claim 11, the operations further comprising:
subsequently to the first period of time, disassociating with the first AP.

17. The processor of claim 11, operations further comprising:
subsequently to the first period of time, transmitting to the second AP, a second indication activating the second link.

18. A method, comprising:
at a first access point (AP):
communicating with a controller, wherein the first AP is associated with a first group of APs managed by the controller;
communicating with a first wireless device;
receiving, from the first wireless device, an indication of roaming;
in response to the indication of roaming:
clearing an uplink reorder buffer of any pending uplink data of the first wireless device; and
transmitting, to the controller, an indication to discontinue providing downlink data for the first wireless device to the first AP; and
transmitting, to the first wireless device, first downlink data, the first downlink data received at the first AP prior to transmitting the indication to discontinue providing downlink data.

19. The method of claim 18, further comprising:
waiting to send the first downlink data to the first wireless device until a first period of time begins.

20. The method of claim 18, further comprising:
receiving a single buffer status report poll (BSRP) from the first wireless device; and
in response to the single BSRP, transmitting a series of BSRP responses to the first wireless device.
